(19) United States
(12) Patent Application Publication
(10) Pub. No.: US 2022/0179769 A1
(43) Pub. Date: Jun. 9, 2022

(54) ESTIMATING CLOUD RESOURCES FOR BATCH PROCESSING

(71) Applicant: International Business Machines Corporation, Armonk, NY (US)

(72) Inventors: Meng Wan, BEIJING (CN); Shuo Li, Beijing (CN); Xiaobo Wang, Beijing (CN); Sheng Yan Sun, Beijing (CN)

(21) Appl. No.: 17/116,867

(22) Filed: Dec. 9, 2020

(51) Int. Cl. G06F 11/34; H04L 29/08; G06F 9/50; G06N 20/00; G06F 9/38

(52) U.S. Cl. CPC G06F 11/3447; H04L 67/1012; G06F 9/5038; G06F 11/3442; G06N 20/00; G06F 9/3822; G06F 9/5061; H04L 67/327

(57) ABSTRACT

Embodiments are disclosed for a method. The method includes determining demand resource for a batch jobs using a resource machine learning model trained to determine a cloud resource that the batch jobs use more than other resources during execution. The method further includes generating resource estimates for the demand resources. Additionally, the method includes determining a batch rating for a batch run using a batch rating machine learning model that is trained to generate a batch rating number based on features representing a priority of the batch run in reference to parallel execution batch runs. The method also includes generating a purchase recommendation for execution of the batch run on a cloud platform based on the resource estimates and the batch rating.

### BACKGROUND

The present disclosure relates to estimating cloud resources, and more specifically, to estimating cloud resources for batch processing.

In computing, the term, batch processing, refers to the execution of groups of programs, i.e., jobs, without user interaction. In one example, batch processing is used to do a relatively large amount of the banking and enterprise computer-processing globally. Enterprises of various sizes execute their batch processing by running batch job pipelines on the shared resources of a public cloud, e.g., computer processing time, computer memory, and the like.

### SUMMARY

Embodiments are disclosed for a method. The method includes determining demand resource for a batch jobs using a resource machine learning model trained to determine a cloud resource that the batch jobs use more than other resources during execution. The method further includes generating resource estimates for the demand resources. Additionally, the method includes determining a batch rating for a batch run using a batch rating machine learning model that is trained to generate a batch rating number based on features representing a priority of the batch run in reference to parallel execution batch runs. The method also includes generating a purchase recommendation for execution of the batch run on a cloud platform based on the resource estimates and the batch rating.

Further aspects of the present disclosure are directed toward systems and computer program products with functionality similar to the functionality discussed above regarding the computer-implemented methods. The present summary is not intended to illustrate each aspect of, every implementation of, and/or every embodiment of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an example system for estimating cloud resources for batch processing, in accordance with some embodiments of the present disclosure.

FIG. 2 is a process flow diagram of an example method for estimating cloud resources for batch processing, in accordance with some embodiments of the present disclosure.

FIG. 3 is a process flow diagram of an example method for making a purchase recommendation, in accordance with some embodiments of the present disclosure.

FIG. 4A is a block diagram of an example one versus one resource classification, in accordance with some embodiments of the present disclosure.

FIG. 4B is a block diagram of an example one versus one resource classification, in accordance with some embodiments of the present disclosure.

FIG. 5 is a process flow diagram of an example method for dynamic purchase recommendations during a batch run, in accordance with some embodiments of the present disclosure.

FIG. 6 is a block diagram of a system for purchase recommendation for batch runs on a public cloud platform, in accordance with some embodiments of the present disclosure

FIG. 7 is a block diagram of an example purchase recommendation manager, in accordance with some embodiments of the present disclosure.

FIG. 8 is a cloud computing environment, in accordance with some embodiments of the present disclosure.

FIG. 9 is a set of functional abstraction model layers provided by the cloud computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

As stated previously, enterprises of various sizes execute their batch processing by running batch job pipelines on the shared resources of public cloud platforms. A batch job pipeline can refer to the execution of a predetermined set of batch jobs, performed in a predetermined order. Each batch job can involve one or more computer programs and commands that create, modify, and otherwise process a common set of files and databases. The batch job pipeline is also referred to herein as a batch run.

Enterprises can purchase public cloud resources for their batch runs. For practical reasons, the public cloud resources are committed before a batch run. While committing too few resources run can be less expensive up front, it can result in longer computational times, which can end up being more expensive long term. As such, the more efficiently these resources are used, the less computationally and/or financially expensive batch processing can be. While overcommitting resources may result in lower computational times, it can increase the financial costs. Accordingly, it can be advantageous to more accurately predict the amount of resources used before the batch jobs run.

Due to the complexity of batch processing, the amount of resources used for efficient processing can vary, which can be challenging to predict. While manual analysis can provide a more accurate estimate of resources, the complexity of batch processing can also make manual analysis financially costly.

Accordingly, embodiments of the present disclosure can provide purchase recommendations for batch processing on public cloud platforms. In some embodiments, a hierarchical machine learning model incorporates a job-level resource use analysis model and a batch-level rating model, to determine a resource price estimate and make a purchase recommendation for public cloud resources based on the estimate.

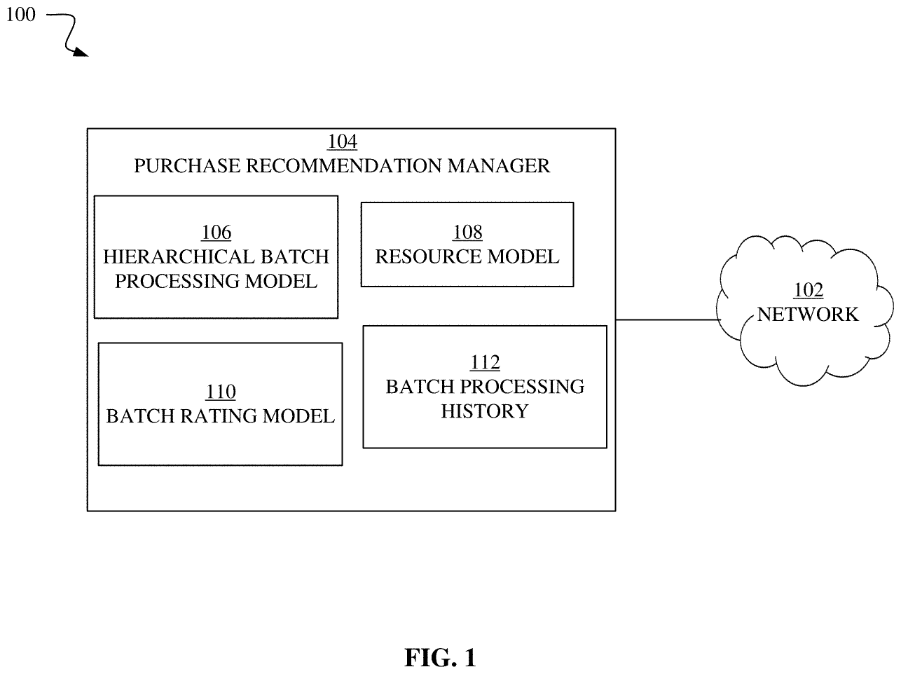

FIG. 1 is a block diagram of an example system 100 for estimating public cloud resources for batch processing, in accordance with some embodiments of the present disclosure. The system 100 includes a network 102 and a purchase recommendation manager 104. The network 102 may be a local area network, wide area network, or collection of computer communication networks that facilitates communication between components of the system 100, specifically, between the hierarchical batch processing model 106, resource model 108, batch rating model 110, and batch processing history 112. In some embodiments, the network 102 can be the Internet.

The purchase recommendation manager 104 can make a purchase recommendation for a batch run using public cloud resources. The purchase recommendation manager 104 can include a hierarchical batch processing model 106, resource model 108, batch rating model 110, and batch processing history 112.

The hierarchical batch processing model 106 can be a hierarchical machine learning model that estimates the public cloud resources to be used by the batch run. The estimate can be based on job resource and batch rating classifications generated by the resource model 108 and batch rating model 110, respectively.

The resource model 108 can identify the comparatively greatest resource that each job of a batch run uses. For example, the resource model 108 can compare the central processing unit (CPU), memory, and disk uses of the job and determine which resource that the job uses more. In some embodiments, the resource model 108 can compare the average CPU, memory, and disk uses of all batch jobs to the historical CPU, memory, and disk use of a job, and identify the comparatively greatest resource based on which resource exceeds the average use by a relatively greatest percentage. Additionally, the resource model 108 can estimate the amount of resource consumption for the job. In some embodiments of the present disclosure, the resource model 108 can include a one versus one multi-classification module, that compares each of the resource uses against each other.

The batch rating model 110 can generate a rating for the batch run based on the batch run's relative priority during parallel batch execution. Parallel batch execution can involve the execution of multiple batch runs. Accordingly, the batch rating can represent a weight for batch-level pricing calibration of the purchase recommendation. In some embodiments of the present disclosure, the batch rating model 110 can use a logistics regression model as a base.

The batch processing history 112 can be one or more computer hosts that contain a history of public cloud resource use by each of the jobs for numerous batch runs. In some embodiments, the purchase recommendation manager 104 can train the batch processing model 106, resource model 108, and batch rating model 110 using the batch processing history 112.

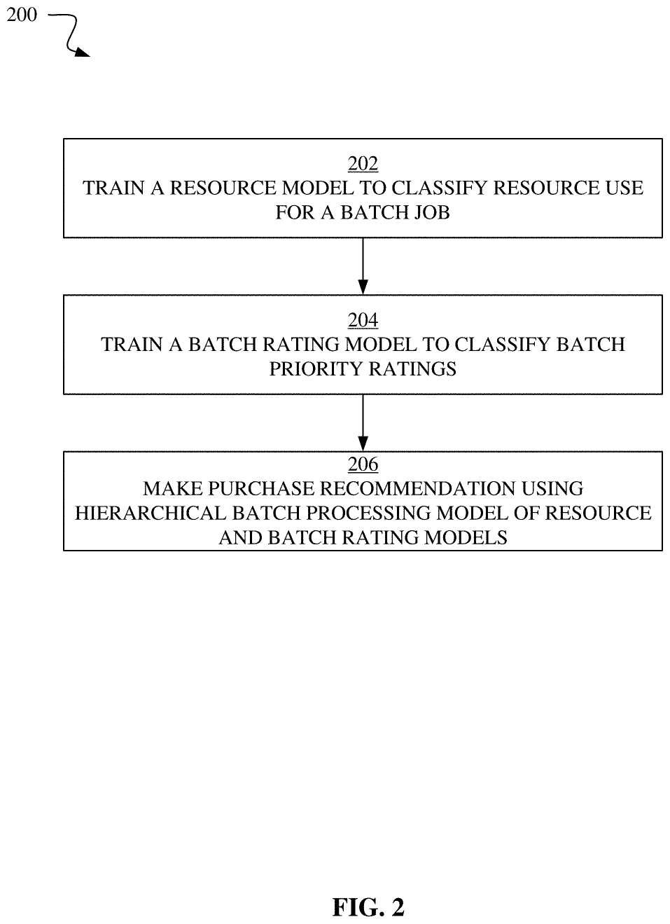

FIG. 2 is a process flow diagram of an example method 200 for estimating cloud resources for batch processing, in accordance with some embodiments of the present disclosure. A purchase recommendation manager, such as the purchase recommendation manager 104 described with respect to FIG. 1, can perform the method 200.

At operation 202, the purchase recommendation manager 104 can train a resource model to classify resource use for a batch job. The resource model can be the resource model 108, for example. Classifying resource use can involve identifying a set of resources for the batch job, and determining which is the relatively most used resource. Additionally, training the resource model can involve generating an estimate of resource use for the identified resource.

At operation 204, the purchase recommendation manager 104 can train a batch rating model to classify batch priority ratings. The batch rating model can be the batch rating model 110. Classifying batch priority ratings can involve using the features of a batch run to generate a numeric value that represents the priority of the batch run in relation to other batch runs that execute in parallel. Features can include, for example, CPU time, database plan or package storage, database pools, virtual storage, real storage, log dataset IO, global dynamic cache, and the like.

At operation 206, the purchase recommendation manager 104 can make a purchase recommendation using a hierarchical batch processing model of the resource model 108 and batch rating model 110. The purchase recommendation can specify the amount of resources to be used for the batch run. In some embodiments of the present disclosure, the hierarchical batch processing model 106 can be a federated-model resulting from the resource model and batch rating model. This means that the hierarchical batch processing model 106 is generated when the resource model 108 and batch rating model 110 are trained. In other words, the hierarchical batch processing model 106 can be a combination of the resource model 108 and batch rating model 110.

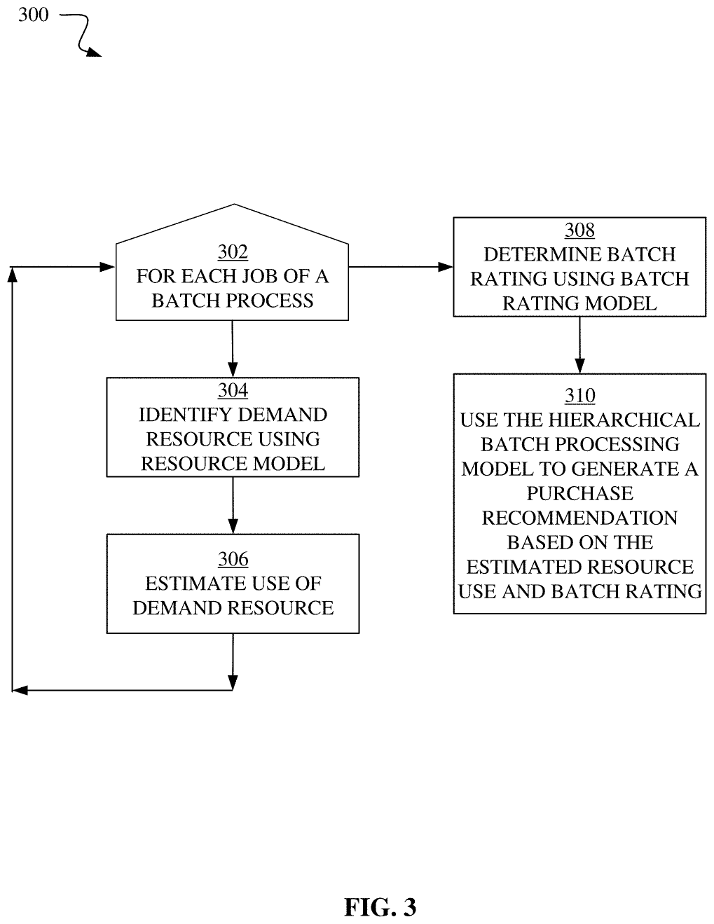

FIG. 3 is a process flow diagram of an example method 300 for making a purchase recommendation, in accordance with some embodiments of the present disclosure. The purchase recommendation manager 104 can perform the method 300 to generate the recommendation for a batch run. The purchase recommendation manager 104 can perform operations 302 through 306 for each job of the batch run.

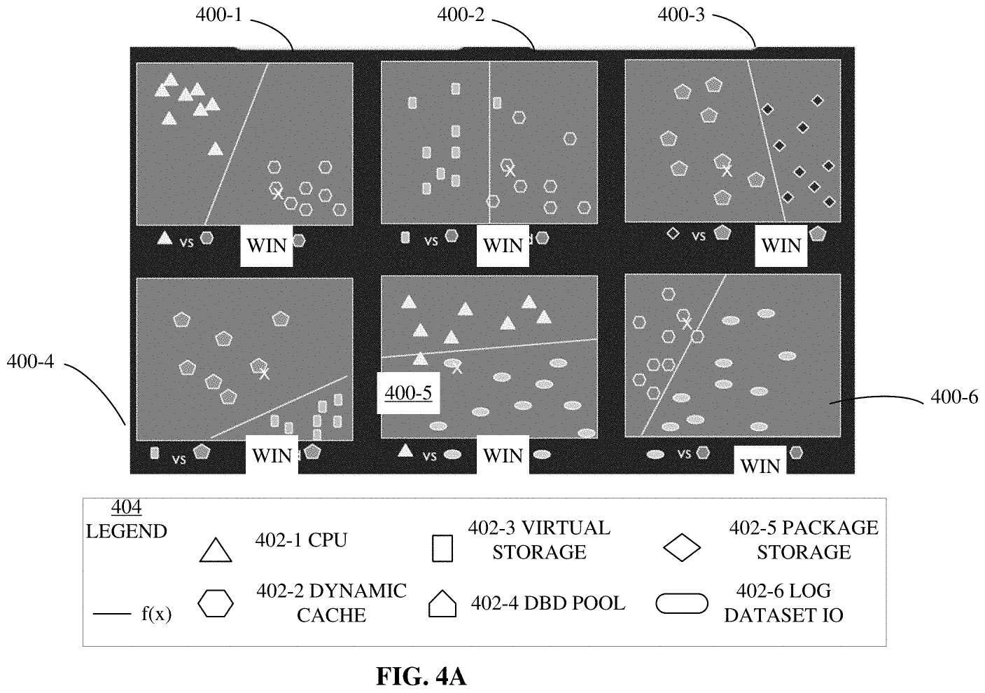

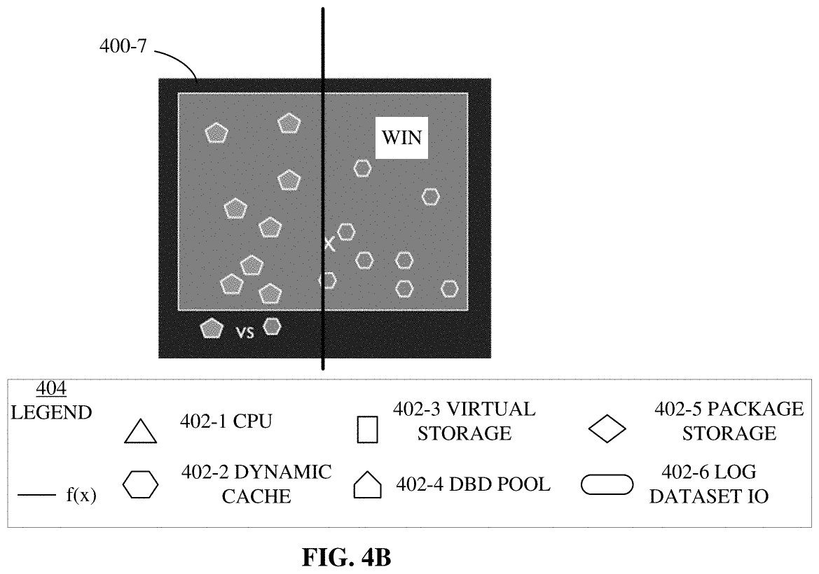

At operation 304, the purchase recommendation manager 104 can identify a demand resource for the batch job. The demand resource can be the resource that the batch job uses more in comparison to other resources used. Identifying the demand resource is described in greater detail with respect to FIGS. 4A-4B.

At operation 306, the purchase recommendation manager 104 can estimate an amount of use of the demand resource. Estimating the amount of the demand resource can involve using a vector of historical use values. EXAMPLE EQUATION 1 represents one possible calculation of the estimated resource amount, where x represents a batch job, N represents the number of times the batch job has run, and g(x) represents the result of a one vs one multi-classification.

$$job ( x ) = g ( x ) \cdot {\sum }_{i = 0}^{N} \frac{{usage}_{i}}{N} \qquad EQUATION 1$$

In this way, g(x) can represent a numeric vector which represents which resource(s) is in comparatively greater use. For example, if the result, e.g, g(x), is the vector [cpu, i/o, dbd pool . . . ], then the result value [1,0,0 . . . ] represents the cpu is the resource with relatively more use.

As stated previously, operations 302 through 306 repeat for each job of a batch run. Control may thus flow to operation 308.

At operation 308, the purchase recommendation manager 104 can determine a batch rating for the batch run using the batch rating model 110. The batch rating can be a numeric value, ranging from 0 to 1, for example, and represent the relative priority of the batch run during parallel execution with other batch runs. The purchase recommendation manager 104 can use a logistics regression model as a base for the batch rating model 110. Additionally, the purchase recommendation manager 104 can extract features about batch runs, such as frequency, time of execution, and the like. Further, the purchase recommendation manager can bin the labels for these features, create a weight of evidence calculation, and perform information value computing.

At operation 310, the purchase recommendation manager 104 can use the hierarchical batch processing model 106 to generate a purchase recommendation based on the estimated resource use and batch rating. EQUATION 2 provides an example calculation of the amount of cloud resource to purchase for a batch run:

$$recommendation = {\sum }_{y = 0}^{K} price \cdot normalized\_score ( y ) \cdot ( {\sum }_{x = 0}^{M} job ( x ) \cdot {\sum }_{i = 0}^{N} \frac{{usage}_{i}}{N} ) \qquad EQUATION 2$$

FIG. 4A is a block diagram of an example one-versus-one (1v1) resource multi-classification, in accordance with some embodiments of the present disclosure. As stated previously, the resource model 108 can identify a demand resource for a batch job. The batch job uses relatively more of the demand resource than the other resources. In some embodiments of the present disclosure, the resource model 108 can identify the demand resource of a batch job by quantitatively comparing each type of resource use against the others. For example, a batch job can use CPU, memory, and storage resources of a public cloud. Accordingly, the resource model 108 can compare the amounts of each type of resource use against the other in a one resource versus one resource classification technique.

This example 1v1 resource classification includes multiple 1v1 classifications 400-1 through 6, also referred to herein collectively as classifications 400. The classifications 400 compare two resources, represented as shapes within each of the comparisons. The shapes are described in a legend 404, wherein the shape for each of the resources, CPU 402-1, dynamic cache 402-2, virtual storage 402-3, database definition (DBD) pool 402-4, package storage 402-5, and log dataset input-output (10) 402-6 are shown next to their descriptions. The resources are also referred to herein, collectively, as resources 402.

The resource model 108 can generate the classifications 400 by using numeric data about the use of each resource 402. By using this numeric data, the resource model 108 can plot each piece of information about the resource use as a cartesian point in two-dimensional space. Where patterns emerge in these two-dimensional spaces, it is possible to quantitatively distinguish relative differences between the amount of use of each resource 402.

More specifically, the resource model 108 classifier can be based on class k(k−1)/2, where k=class size. Thus, for a class size, k=6, 6(6−1)/2=15. In other words, the resource model 108 can use a 15 classifier. Classifications 400 represent 6 classes as an example. The resource model classifier computes the winner of multiple classifications 400 described in EQUATION 3, where x represents n in classification 400-n.

The classifier “votes” for a winner of the 1v1 classification. Each winner resource of the classification can earn a point; and, after multiple comparisons between all resources 402, the winner is the resource 402 that wins the most classifications. In other words, the winning class, i.e., resource is determined according to EQUATION 4

CLASS=MAX{resource 402-1 through n} EQUATION 4

For example, in classification 400-1, the resource model 108 is comparing use of the CPU 402-1 and dynamic cache 402-2. Based on the plot points of each shape, it is possible to draw a line between each set of shapes. Further, it is possible to partition the set of shapes in 2D space in a way that one resource is more dominant in the total space than the other. Accordingly, the resource model 108 can vote for the dominant resource as the winner of the 1v1 comparison. In the classification 400-1, the winner is the dynamic cache 402-2. Based on this comparison, this batch job may use more dynamic cache 402-2 than CPU 402-1.

In classification 400-2, the resource model 108 is comparing use of the virtual storage 402-3 and dynamic cache 402-2. As shown, the winner is the dynamic cache 402-2. Based on this comparison, this batch job may use more dynamic cache 402-2 than virtual storage 402-3.

In classification 400-3, the resource model 108 is comparing use of the package storage 402-5 and DBD pool 402-4. As shown, the winner is the DBD pool 402-4. Based on this comparison, this batch job may use more DBD pool 402-4 than package storage 402-5. In some comparisons, it may not be possible to draw a line between all of the points of the classifications 400. In such cases, a relatively small number of points from one set may appear on the edge line. For example, in classifications 400-3 through 400-6, there is one plot point on the edge line. The edge line point indicates the point may belong to both of classes. Determining how to handle edge points is described in greater detail with respect to FIG. 4B. Edge line points are possible because in some cases, a batch job can incur above average usage rates on more than one resource, thus superseding the remaining resources.

In classification 400-4, the resource model 108 is comparing use of the DBD pool 402-4 and virtual storage 402-3. As shown, the winner is the DBD pool 402-4. Based on this comparison, this batch job may use more DBD pool 402-4 than virtual storage 402-3.

In classification 400-5, the resource model 108 is comparing use of the CPU 402-1 and log dataset IO 402-6. As shown, the winner is the log dataset IO 402-6. Based on this comparison, this batch job may use more log dataset IO 402-6 than CPU 402-1.

In classification 400-6, the resource model 108 is comparing use of the dynamic cache 402-2 and log dataset IO 402-6. As shown, the winner is the dynamic cache 402-2. Based on this comparison, this batch job may use more dynamic cache 402-2 than log dataset IO 402-6. Based on classifications 400-1 through 6, the winning class is dynamic cache 402-2 with 3 wins, compared to 2 wins for CPU 402-1 and 1 win for log dataset IO 402-6.

FIG. 4B is a block diagram of an example one versus one resource classification 400-7, in accordance with some embodiments of the present disclosure. In this example, the resource on f(x) does not belong exclusively to either side. In such cases, the resource model classifier can incorporate a soft classifier that determines the probabilities of the resource 402 belonging to either side. More specifically, the equation can indicate the probability that the edge line point belongs to one or another class. The equation is based on the soft-classifier algorithm.

For example, if an edge point has 0.65 (green) and 0.35 (blue), it indicates the data will leverage both CPU and DBD pool. And the CPU has 0.65 possibility more than DBD 0.35 possibility.

Thus, according to EQUATION 5:

g(x)=argmax_{k∈y}θ(W_{[k]}^{T}x) EQUATION 5

Whereas points exclusively on either side of f(x) can represent 100% probabilities of their respective classifications, the resource model soft classifier can determine a 65% probability of belonging to dynamic cache 402-2 and a 35% probability of belonging to DBD pool 402-4.

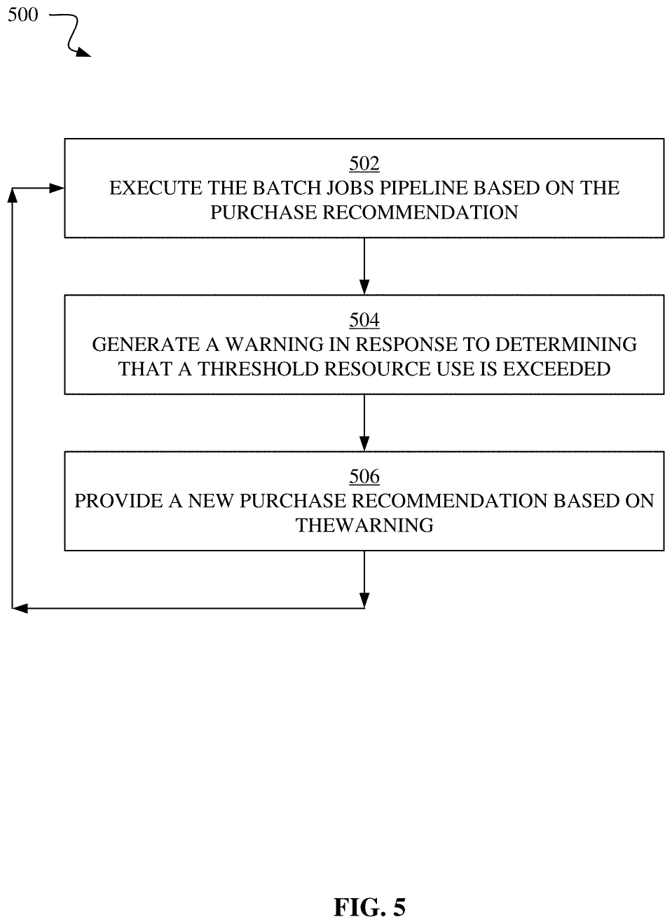

FIG. 5 is a process flow diagram of an example method 500 for dynamic purchase recommendations during a batch run, in accordance with some embodiments of the present disclosure. A public cloud platform and the purchase recommendation manager 104 can perform the method 500 to generate the recommendation for a batch run. The purchase recommendation manager 104 can perform operations 502 through 506 for each job of the batch run.

At operation 502, the public cloud platform can begin to execute a batch run. The initial assignment of public cloud resources to the batch run may be based on a purchase recommendation generated as described above.

At operation 504, the purchase recommendation manager may generate a warning in response to determining that a threshold resource use is exceeded. In some embodiments of the present disclosure, the purchase recommendation manager 104 can include a job monitor. The job monitor can track the availability of resources assigned to the batch run. Additionally, the job monitor can determine if the resource use is approaching the limits of the assigned resource. For example, the job monitor may use a 10% threshold, where a batch run that has 10% or fewer remaining of a resource meets the threshold. In response, the job monitor can generate the warning.

At operation 506, the purchase recommendation manager 104 can generate a new purchase recommendation based on the warning. The purchase recommendation manager 104 can request new classifications from the resource model 108 to determine a new estimate of resource use that is based on the type of resource that triggers the threshold warning. Accordingly, the purchase recommendation manager 104 can make a new purchase recommendation based on the new resource estimate.

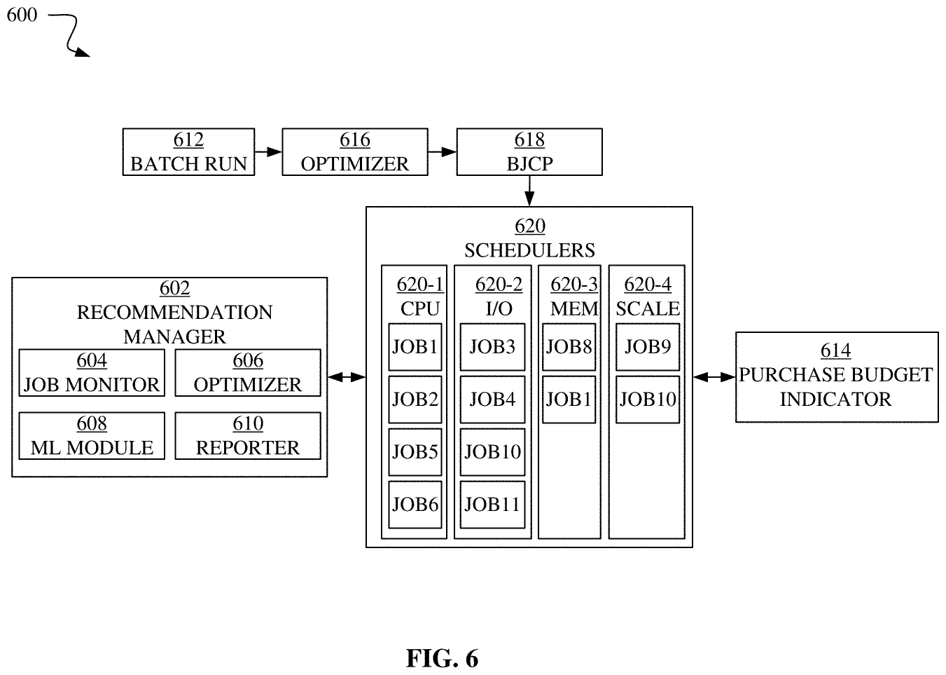

FIG. 6 is a block diagram of a system 600 for purchase recommendation for batch runs on a public cloud platform, in accordance with some embodiments of the present disclosure. The system 600 includes purchase recommendation manager 602. The purchase recommendation manager 602 is similar to the purchase recommendation manager 104. Further, the purchase recommendation manager 602 includes a job monitor 604, optimizer 606, machine learning (ML) module 608, and a reporter 610. The job monitor 604 can track resource use by a batch run 612 executing on the public cloud platform. Additionally, the job monitor 604 can indicate a threshold warning to a purchase budget indicator 614. The purchase budget indicator 614 can trigger a warning based on the type of resource crossing the threshold use. The purchase budget indicator 614 can be a reversed controller, where estimates of future resource use are pessimistic.

The optimizer 606 is a job-level database optimizer. The job-level database optimizer is a database module that is responsible for job arrangement and schedule. The ML module 608 can incorporate the machine learning features described with respect to the resource model 108 and batch rating model 110. The system reporter 610 can be similar to the batch processing history 112.

In the system 600, the batch run 612 can be input to an optimizer 616. The optimizer 616 can be a database optimizer that binds the batch jobs to a database. The database optimizer 616 can be a performance-module of a database, and which can derive the job resource consumption for every batch job, e.g. how much CPU, I/O, DBD pool, and the like. Further, the database optimizer 116 can do some optimization if configured accordingly by the database administrator.

Additionally, through the optimizer 616, the batch run 612 can be input to a batch job classification process (BJCP) 618. The batch job classification process 618 can involve assigning resources of a purchase recommendation to the batch run 612. More specifically, the schedulers 620 for the public cloud resources thus assign their respective resources to the batch run.

In this example, each of jobs 1 through 11 of a batch run are assigned to respective resources. As shown, job1, job2, job5, and job6 are assigned to the scheduler for CPU 620-1; job3, job4, job10, and job11 are assigned to the scheduler for I/O 620-2; job8 and job 1 are assigned to the scheduler for MEM 620-3; and, job 9 and job 10 are assigned to the scheduler for scale 620-4.

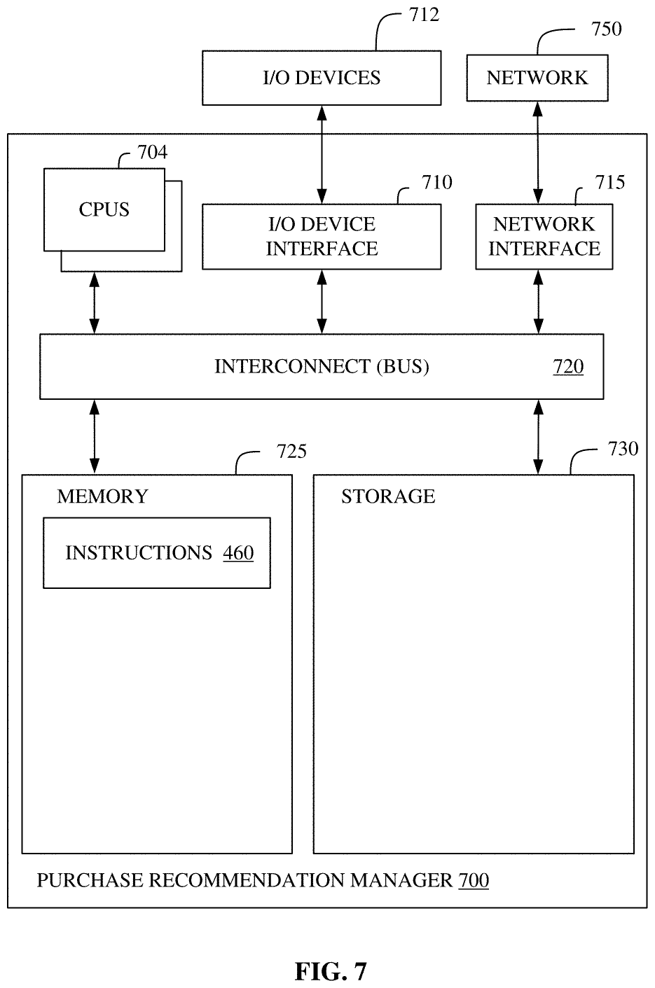

FIG. 7 is a block diagram of an example purchase recommendation manager 700, in accordance with some embodiments of the present disclosure. In various embodiments, the purchase recommendation manager 700 is similar to the purchase recommendation manager 104 and can perform the methods described in FIGS. 2, 3, and/or 5 and/or the functionality discussed in FIGS. 1, 4A, 4B, and/or 6. In some embodiments, the purchase recommendation manager 700 provides instructions for the aforementioned methods and/or functionalities to a client machine such that the client machine executes the method, or a portion of the method, based on the instructions provided by the purchase recommendation manager 700. In some embodiments, the purchase recommendation manager 700 comprises software executing on hardware incorporated into a plurality of devices.

The purchase recommendation manager 700 includes a memory 725, storage 730, an interconnect (e.g., BUS) 720, one or more CPUs 705 (also referred to as processors 705 herein), an I/O device interface 710, I/O devices 712, and a network interface 715.

Each CPU 705 retrieves and executes programming instructions stored in the memory 725 or the storage 730. The interconnect 720 is used to move data, such as programming instructions, between the CPUs 705, I/O device interface 710, storage 730, network interface 715, and memory 725. The interconnect 720 can be implemented using one or more busses. The CPUs 705 can be a single CPU, multiple CPUs, or a single CPU having multiple processing cores in various embodiments. In some embodiments, a CPU 705 can be a digital signal processor (DSP). In some embodiments, CPU 705 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 725 is generally included to be representative of a random access memory (e.g., static random access memory (SRAM), dynamic random access memory (DRAM), or Flash). The storage 730 is generally included to be representative of a non-volatile memory, such as a hard disk drive, solid state device (SSD), removable memory cards, optical storage, and/or flash memory devices. Additionally, the storage 730 can include storage area-network (SAN) devices, the cloud, or other devices connected to the purchase recommendation manager 700 via the I/O device interface 710 or to a network 750 via the network interface 715.

In some embodiments, the memory 725 stores instructions 760. However, in various embodiments, the instructions 760 are stored partially in memory 725 and partially in storage 730, or they are stored entirely in memory 725 or entirely in storage 730, or they are accessed over a network 750 via the network interface 715.

Instructions 760 can be processor-executable instructions for performing any portion of, or all, any of the methods described in FIGS. 2, 3, and/or 5 and/or the functionality discussed in FIGS. 1, 4A, 4B, and/or 6.

In various embodiments, the I/O devices 712 include an interface capable of presenting information and receiving input. For example, I/O devices 712 can present information to a listener interacting with purchase recommendation manager 700 and receive input from the listener.

The purchase recommendation manager 700 is connected to the network 750 via the network interface 715. Network 750 can comprise a physical, wireless, cellular, or different network.

In some embodiments, the purchase recommendation manager 700 can be a multi-user mainframe computer system, a single-user system, or a server computer or similar device that has little or no direct user interface but receives requests from other computer systems (clients). Further, in some embodiments, the purchase recommendation manager 700 can be implemented as a desktop computer, portable computer, laptop or notebook computer, tablet computer, pocket computer, telephone, smart phone, network switches or routers, or any other appropriate type of electronic device.

It is noted that FIG. 7 is intended to depict the representative major components of an exemplary purchase recommendation manager 700. In some embodiments, however, individual components can have greater or lesser complexity than as represented in FIG. 7, components other than or in addition to those shown in FIG. 7 can be present, and the number, type, and configuration of such components can vary.

Although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third-party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third-party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

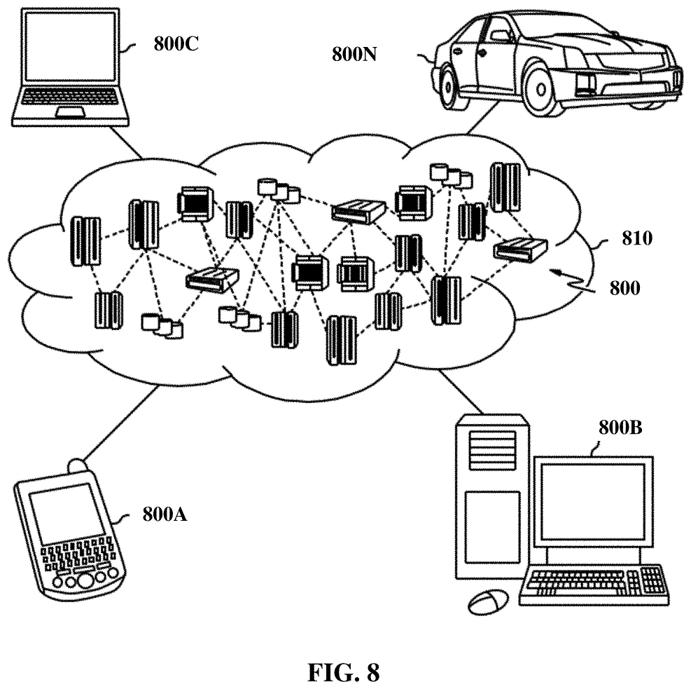

FIG. 8 is a cloud computing environment 810, according to some embodiments of the present disclosure. As shown, cloud computing environment 810 includes one or more cloud computing nodes 800. The cloud computing nodes 800 can perform the methods described in FIGS. 2, 3 and/or 5 and/or the functionality discussed in FIGS. 1, 4A, 4B, and/or 6. Additionally, cloud computing nodes 800 can communicate with local computing devices used by cloud consumers, such as, for example, personal digital assistant (PDA) or cellular telephone 800A, desktop computer 800B, laptop computer 800C, and/or automobile computer system 800N. Further, the cloud computing nodes 800 can communicate with one another. The cloud computing nodes 800 can also be grouped (not shown) physically or virtually, in one or more networks, such as Private, Community, Public, or Hybrid clouds as described hereinabove, or a combination thereof. This allows cloud computing environment 810 to offer infrastructure, platforms and/or software as services for which a cloud consumer does not need to maintain resources on a local computing device. It is understood that the types of computing devices 800A-N shown in FIG. 8 are intended to be illustrative only and that computing nodes 800 and cloud computing environment 810 can communicate with any type of computerized device over any type of network and/or network addressable connection (e.g., using a web browser).

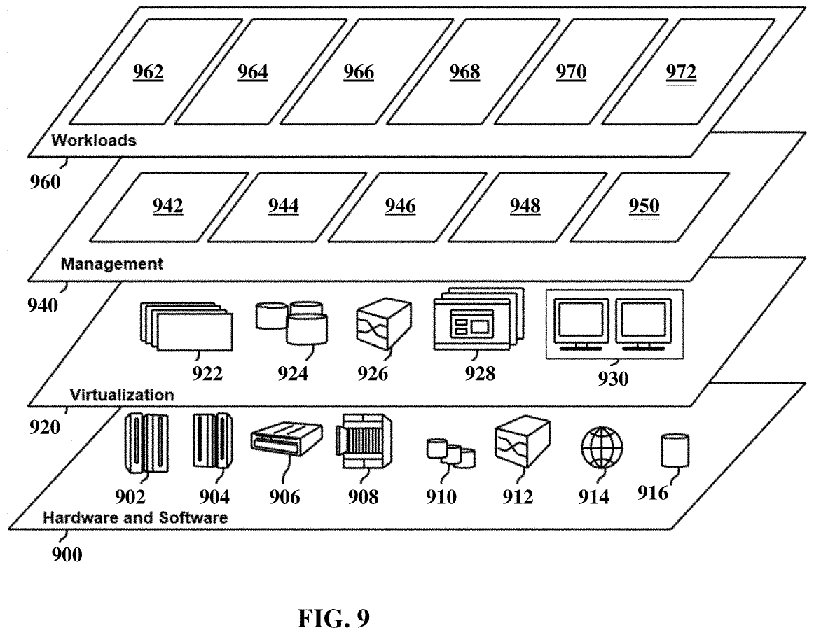

FIG. 9 is a set of functional abstraction model layers provided by cloud computing environment 810 (FIG. 8), according to some embodiments of the present disclosure. It should be understood in advance that the components, layers, and functions shown in FIG. 9 are intended to be illustrative only and embodiments of the disclosure are not limited thereto. As depicted below, the following layers and corresponding functions are provided.

Hardware and software layer 900 includes hardware and software components. Examples of hardware components include: mainframes 902; RISC (Reduced Instruction Set Computer) architecture based servers 904; servers 906; blade servers 908; storage devices 910; and networks and networking components 912. In some embodiments, software components include network application server software 914 and database software 916.

Virtualization layer 920 provides an abstraction layer from which the following examples of virtual entities can be provided: virtual servers 922; virtual storage 924; virtual networks 926, including virtual private networks; virtual applications and operating systems 928; and virtual clients 930.

In one example, management layer 940 can provide the functions described below. Resource provisioning 942 provides dynamic procurement of computing resources and other resources that are utilized to perform tasks within the cloud computing environment. Metering and Pricing 944 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 946 provides access to the cloud computing environment for consumers and system administrators. Service level management 948 provides cloud computing resource allocation and management such that required service levels are met. Service level management 948 can allocate suitable processing power and memory to process static sensor data. Service Level Agreement (SLA) planning and fulfillment 950 provide pre-arrangement for, and procurement of, cloud computing resources for which a future requirement is anticipated in accordance with an SLA.

Workloads layer 960 provides examples of functionality for which the cloud computing environment can be utilized. Examples of workloads and functions which can be provided from this layer include: mapping and navigation 962; software development and lifecycle management 964; virtual classroom education delivery 966; data analytics processing 968; transaction processing 970; and purchase recommendation manager 972.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method, comprising:
determining a plurality of demand resource for a corresponding plurality of batch jobs using a resource machine learning model trained to determine a cloud resource that the corresponding batch jobs use more than other resources during execution;
generating a corresponding plurality of resource estimates for the demand resources of the corresponding batch jobs;
determining a batch rating for a batch run using a batch rating machine learning model that is trained to generate a batch rating number based on a plurality of features representing a priority of the batch run in reference to a plurality of parallel execution batch runs; and
generating a purchase recommendation for execution of the batch run on a cloud platform based on the resource estimates and the batch rating.

2. The method of claim 1, further comprising executing the batch run on a public cloud platform comprising the demand resources.

3. The method of claim 1, wherein the batch run comprises an execution pipeline of the batch jobs.

4. The method of claim 1, comprising training the resource model using a one-versus-one (1v1) classifier on resources that the batch jobs use.

5. The method of claim 4, wherein the 1v1 classifier performs multiple classifications between two of the resources.

6. The method of claim 5, wherein the 1v1 classifier assigns a plurality of point values to each of the resources based on how many classifications a resource wins.

7. The method of claim 6, wherein identifying the demand resources comprises determining a resource with an assigned point value higher than one or more remaining resources.

8. A computer program product comprising program instructions collectively stored on one or more computer readable storage media, the program instructions executable by one or more processors to cause the one or more processors to perform a method comprising:
determining a plurality of demand resource for a corresponding plurality of batch jobs using a resource machine learning model trained to determine a cloud resource that the corresponding batch jobs use more than other resources during execution;
generating a corresponding plurality of resource estimates for the demand resources of the corresponding batch jobs;
determining a batch rating for a batch run using a batch rating machine learning model that is trained to generate a batch rating number based on a plurality of features representing a priority of the batch run in reference to a plurality of parallel execution batch runs; and
generating a purchase recommendation for execution of the batch run on a cloud platform based on the resource estimates and the batch rating.

9. The computer program product of claim 8, the method further comprising executing the batch run on a public cloud platform comprising the demand resources.

10. The computer program product of claim 8, wherein the batch run comprises an execution pipeline of the batch jobs.

11. The computer program product of claim 10, the method further comprising training the resource model using a one-versus-one (1v1) classifier on resources that the batch jobs use.

12. The computer program product of claim 11, wherein the 1v1 classifier performs multiple classifications between two of the resources.

13. The computer program product of claim 12, wherein the 1v1 classifier assigns a plurality of point values to each of the resources based on how many classifications a resource wins.

14. The computer program product of claim 13, wherein identifying the demand resources comprises determining a resource with an assigned point value higher than one or more remaining resources.

15. A system comprising:
a computer processing circuit; and
a computer-readable storage medium storing instructions, which, when executed by the computer processing circuit, are configured to cause the computer processing circuit to perform a method comprising:
determining a plurality of demand resource for a corresponding plurality of batch jobs using a resource machine learning model trained to determine a cloud resource that the corresponding batch jobs use more than other resources during execution;
generating a corresponding plurality of resource estimates for the demand resources of the corresponding batch jobs;
determining a batch rating for a batch run using a batch rating machine learning model that is trained to generate a batch rating number based on a plurality of features representing a priority of the batch run in reference to a plurality of parallel execution batch runs; and
generating a purchase recommendation for execution of the batch run on a cloud platform based on the resource estimates and the batch rating.

16. The system of claim 15, the method further comprising executing the batch run on a public cloud platform comprising the demand resources.

17. The system of claim 16, wherein the batch run comprises an execution pipeline of the batch jobs.

18. The system of claim 17, the method further comprising training the resource model using a one-versus-one (1v1) classifier on resources that the batch jobs use.

19. The system of claim 18, wherein the 1v1 classifier performs multiple classifications between two of the resources.

20. The system of claim 19, wherein the 1v1 classifier assigns a plurality of point values to each of the resources based on how many classifications a resource wins, and identifying the demand resources comprises determining a resource with an assigned point value higher than one or more remaining resources.
